(19) United States
(12) Patent Application Publication
(10) Pub. No.: US 2007/0097088 A1
(43) Pub. Date: May 3, 2007

(54) Imaging device scrolling touch pad with tap points

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,417

(22) Filed: Oct. 31, 2005

(51) Int. Cl. G09G 5/00

(52) U.S. Cl. 345/173

(57) ABSTRACT

An exemplary method for controlling an electronic imaging device may include detecting a sweeping motion on a touch pad, and scrolling a feature of the electronic imaging device in response. The method may also include detecting a tap on a predetermined location on the touch pad, and in response selecting one of a plurality of features of the electronic imaging device to be scrolled when a next sweeping motion is detected on the touch pad.

U.S. patent application Ser. No. ______, of Amy E. Battles (attorney docket no. 200506124-1), filed on the same day as this application, U.S. patent application Ser. No. ______, of Amy E. Battles, Daniel J. Byrne, Shanshan Li and Norman C. Pyle (attorney docket no. 200506156-1) filed on the same day as this application, U.S. patent application Ser. No. ______, of Amy E. Battles, Shanshan Li and Norman C. Pyle (attorney docket no. 200506158-1) filed on the same day as this application, U.S. patent application Ser. No. ______, of Amy E. Battles (attorney docket no. 200506125-1) filed on the same day as this application and U.S. patent application Ser. No. ______, of Mark J. Bianchi, Norman C. Pyle, Amy E. Battles, Shanshan Li and Daniel J. Byrne, (attorney docket no. 200506123-1) filed on the same day as this application, are all hereby incorporated by reference for all that is disclosed therein.

### BACKGROUND

Electronic imaging devices such as digital cameras are used in a wide range of applications and are steadily becoming less expensive and simpler to use. Electronic images may be stored indefinitely without the image degradation suffered by film-based images. Electronic imaging devices generate images that can be viewed immediately and used in a variety of ways such as printing, posting to a web page on the World Wide Web, transmitting to others by electronic mail or other means, etc. They can also rapidly capture large numbers of images that can be previewed and stored or deleted as desired.

As electronic imaging devices get smaller, it becomes increasingly valuable to combine controls. One method that has been used in the past is to combine the zoom control (wide angle/telephoto) with arrow keys (either left/right or up/down). This works well for the most part, but causes problems in certain areas of the user interface where all four arrows and the zoom must be active at the same time. This occurs, for example, in the magnify view where the four arrows are used to pan around an image, while the zoom controls the level of magnification. It also occurs in thumbnail view where the four arrows are used to navigate around and select different thumbnails, while the zoom out is active to return to full-screen single-image view.

### BRIEF DESCRIPTION OF THE DRAWINGS

Illustrative embodiments are shown in the accompanying drawings as described below.

FIG. 1 is an isometric front view illustration of an exemplary electronic imaging device.

FIG. 2 is an isometric rear view illustration of the exemplary electronic imaging device of FIG. 1.

FIG. 3 is a block diagram of an exemplary embodiment of an electronic imaging device.

FIG. 4 is a flow chart of an exemplary operation for controlling an electronic imaging device using a touch pad with tap points.

FIG. 5 is a rear elevation view of an exemplary electronic imaging device having a rotary touch pad with tap points.

FIG. 6 is a rear elevation view of an exemplary electronic imaging device having a linear touch pad with tap points.

### DESCRIPTION

The drawing and description, in general, disclose an imaging device having a scrolling touch pad in which tap points select the function of the scrolling touch pad. This enables the touch pad to control multiple functions on the electronic imaging device, minimizing the amount of hardware required for the user interface and providing a simple, adaptable user interface.

In one exemplary embodiment, an electronic imaging device such as a digital camera or video camera may be used to capture and review or play back images under the control of the touch pad and other user inputs, if any. The touch pad may be used to control features of the electronic imaging device such as manual focus, aperture setting, and zoom in capture mode, or scrolling through images and magnifying a displayed image in playback mode. The feature being controlled by the touch pad may be selected by tapping on a tap point on the touch pad. The tap points may comprise predetermined locations on the touch pad having icons displayed thereon to indicate the associated function. The feature selected by each tap point may be static or may vary depending on the state of the electronic imaging device, as will be described in more detail below.

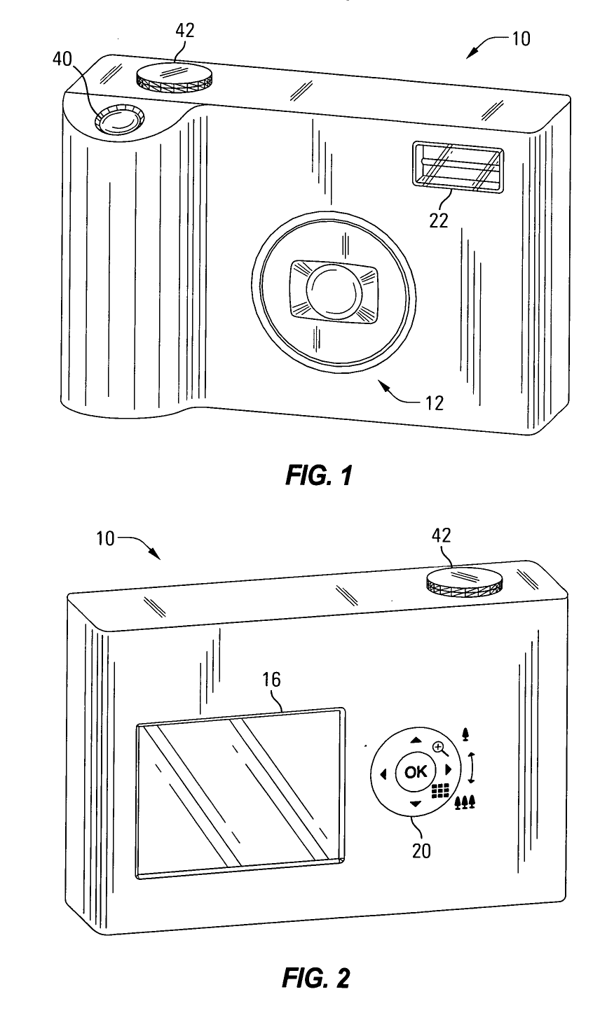

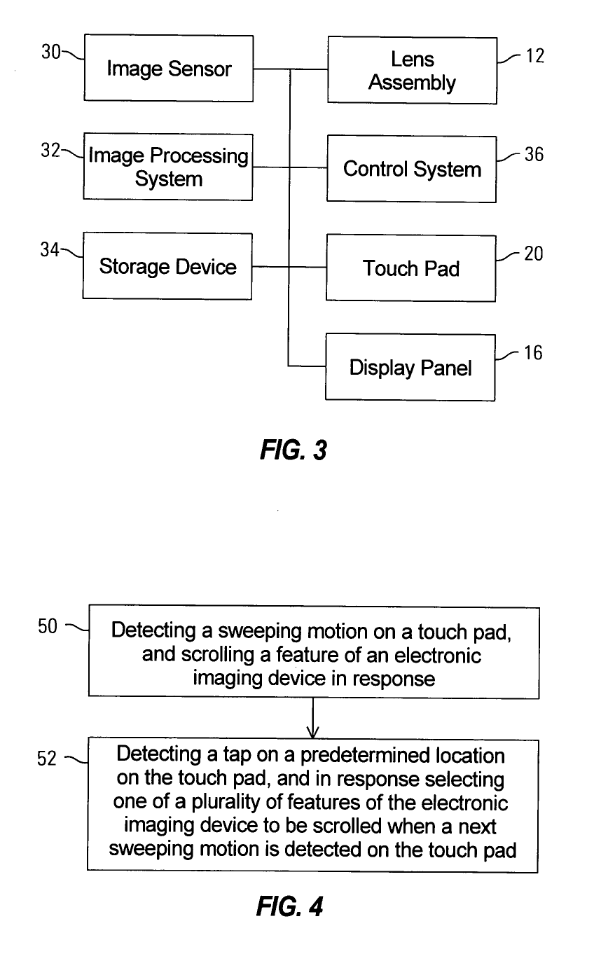

Before continuing to describe the touch pad and tap points in more detail, an exemplary digital camera 10 (FIGS. 1-3) which may employ a touch pad with tap points will be described. However, it is important to note that the touch pad with tap points is not limited to any particular type of electronic imaging device, and the digital camera 10 discussed herein is purely exemplary. The digital camera 10 includes a lens assembly 12, display panel 16, touch pad 20, and flash 22. The digital camera also includes an image sensor 30, an image processing system 32 to process and format the image data, and a storage device 34 to store the image data collected by the image sensor 30. A user interface is implemented in the digital camera 10 by a control system 36, including accepting user input via the touch pad 20 and other inputs such as a shutter control button 40, and controlling the settings and functions of the digital camera 10. A mode dial 42 may be included to control various functions of the digital camera 10, such as power on/off and mode select including playback or image capture. Alternatively, these types of functions may be controlled in any suitable manner, such as with other switches or buttons or using a menu system. The digital camera 10 may also include a power source such as a battery. Each of the foregoing exemplary systems and devices will now be described.

Image light enters the digital camera 10 through the lens assembly 12. The image sensor 30, a charge-coupled device (CCD) or other image sensor, detects the image light focused thereon by the lens assembly 12. A typical CCD comprises an array of individual cells or pixels, each of which collects or builds-up an electrical charge in response to exposure to light. Because the quantity of the accumulated electrical charge in any given cell or pixel is related to the intensity and duration of the light exposure, a CCD may be used to detect light and dark spots in an image focused thereon.

The term image light as used herein refers to the light, visible or otherwise, that is focused onto the surface of the image sensor 30 by the lens assembly 12. The image light may be converted into digital image data in essentially three steps. First, each pixel in the CCD detector converts the light it receives into an electric charge. Second, the charges from the pixels are converted into analog voltages by an analog amplifier. Finally, the analog voltages are digitized by an analog-to-digital (A/D) converter, generating numeric representations of the amplitudes of the analog voltages. The digital image data then may be processed and/or stored as desired.

The image processing system 32 processes and formats the image data, either before or after storage in the storage device 34. The image processing system 32 comprises a microprocessor and associated memory. Alternatively, the image processing system 32 may comprise a hard-coded device such as an application specific integrated circuit (ASIC), or some combination of these devices. The storage device 34 stores the image data collected by the image sensor 30. The storage device 34 comprises a removable rewriteable non-volatile memory such as a flash media card, or may comprise a random access memory (RAM), or a magnetic, optical, or other solid state storage medium.

The display panel 16 comprises a liquid crystal display (LCD) or any other suitable display device and is used to display a live view of the subject in capture mode, or to display thumbnails or stored images in playback mode, as well as menus, status information, etc.

The control system 36 may comprise a microprocessor and associated firmware or software to provide a user interface and to control the digital camera 10. The control system 36 and image processing system 32 may share a single microprocessor, or may each have a dedicated microprocessor. Alternatively, the control system 36 may comprise a hard-coded device such as an application specific integrated circuit (ASIC), or some combination of these devices.

The digital camera 10 may also include other components, such as an audio system. However, because digital cameras are well-known in the art and could be provided by persons having ordinary skill in the art after having become familiar with the teachings of the present disclosure, the digital camera 10 utilized in one embodiment, as well as the various ancillary systems and devices (e.g., battery systems and storage devices) that may be utilized in one embodiment will not be described in further detail herein.

During operation of the digital camera 10, the digital camera 10 is turned on and placed in image capture mode using one or more control inputs such as the mode dial 42. The digital camera 10 is oriented with the lens assembly 12 directed at a subject. A live view of the subject may be monitored on the display panel 16. The lens assembly 12 is focused on the subject, either automatically or manually, and zoomed to the desired focal length. When the digital camera 10 is properly oriented and focused, the shutter control button 40 is pressed. The flash 22 illuminates the subject, if needed. The image sensor 30 converts the image light directed thereon by the lens assembly 12 into electrical image data. The image processing system 32 processes the image data, displays the captured image on the display panel 16 and stores the image data in one or more files on the storage device 34. The digital camera 10 may also be placed in playback mode using one or more control inputs such as the mode dial 42. The touch pad 20 may be used to scroll through images stored on the storage device 34, either one by one in single image full screen view on the display panel 16 or by navigating or scrolling through an array of thumbnail images displayed on the display panel 16. Images in full screen view may be magnified or zoomed and panned to select the magnified image portion to display.

The touch pad 20 may be used to control various features, such as manual focus, zoom, aperture and shutter speed in capture mode, or image selection, magnification and panning in playback mode. The feature being controlled by the touch pad 20 may be selected by tapping on tap points on the touch pad 20. The selected feature for a given tap point may vary based on the current state of the electronic imaging device, such as the mode (capture or playback) or the display state (full screen view versus thumbnail array, zoomed or full image, etc.). An exemplary operation for controlling an electronic imaging device using a touch pad 20 with tap points is summarized in the flow chart of FIG. 4. When a sweeping motion across the touch pad is detected 50, a feature of the electronic imaging device is scrolled or adjusted in response. When a tap on a predetermined location or tap point on the touch pad 20 is detected 52, one of the features of the electronic imaging device is selected to be scrolled by the touch pad 20.

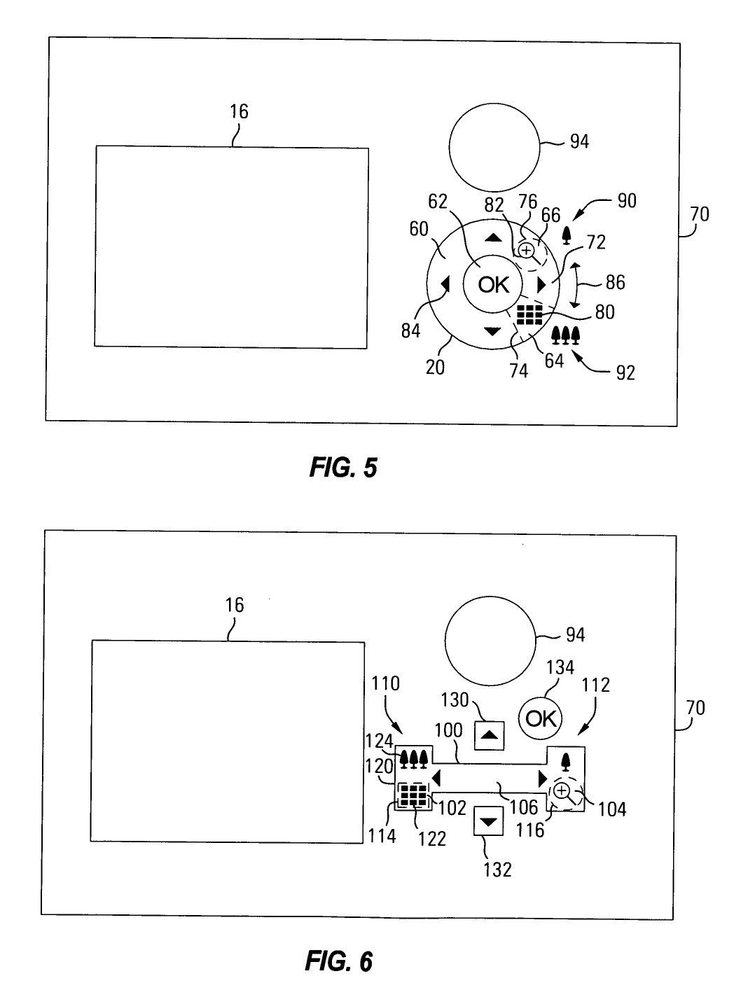

Referring to FIG. 5, an exemplary embodiment of a touch pad 20 with tap points and its use in controlling an electronic imaging device will now be described in more detail. The touch pad 20 has a surface that may comprise any device sensitive to touch that is now known or that may be developed in the future. For example, the touch pad 20 may be sensitive to pressure against its surface, or may detect the proximity of an object in any manner. Furthermore, the touch pad 20 may be adapted to detect a proximate object without physical contact between the object and the touch pad 20 if desired. The touch pad 20 may be activated by any suitable object, such as a user's finger, a stylus, etc. The touch pad 20 may comprise a single touch sensitive surface in any desired shape or configuration, or may comprise a plurality of active elements that act in combination to form the touch sensitive surface for the touch pad 20. The touch pad 20 may have one or more outputs connected to the control system 36 enabling it to detect and identify various types of activation events, such as a sweeping movement of an object over or adjacent the touch pad 20, or a tapping or approach by an object substantially in a single region of the touch pad 20 without significant lateral movement across the touch pad 20.

The exemplary touch pad 20 illustrated in FIG. 5 is a rotary touch pad having an annular region 60 surrounding a circular center button region 62. The annular region 60 and circular center button region 62 may be formed as a single integral touch sensitive surface, or may be formed by two or more separate contiguous elements. An annular inactive region may also be provided around the circular center button region 62 to provide isolation between the annular region 60 and the circular center button region 62 if desired. The touch sensitive surface of the touch pad 20 may be formed in the circular or annular shape, or may have a rectangular or other shape with a circular window or template over the touch sensitive surface to define the outer perimeter of the annular shape.

The exemplary touch pad 20 includes two tap points 64 and 66 that may be tapped to change the feature that is controlled by the touch pad 20. Any desired number of tap points may be included on the touch pad 20 to enable the user to select different features or modes for the touch pad 20. The tap points 64 and 66 may located in any desired region of the touch pad 20. For example, the two exemplary tap points 64 and 66 are located in the lower right and upper right regions of the touch pad 20, placing them closest to a right side 70 of the electronic imaging device for convenient access to a users thumb. The two exemplary tap points 64 and 66 may be separated by a scrolling, non-tap, region 72 if desired. Note that the tap points 64 and 66 also form part of the scrolling touch pad, so that sweeping movements may be detected as they pass over the tap points 64 and 66. Contact on the tap points 64 and 66 only alters the function of the touch pad 20 when they are tapped without significant lateral motion. The tap points 64 and 66 may be sized and shaped as desired. For example, the tap points (e.g., 64) may have a wedge shape 74 on the ring portion of the annular region 60, or (e.g., 66) a circular shape 76, or any other desired shape and size.

An icon or graphic may be displayed adjacent each tap point if desired, to suggest or indicate the feature associated with each tap point. For example, one exemplary tap point 64 has an array icon 80, suggesting that the tap point 64 selects a thumbnail array display. Another exemplary tap point 66 has a magnifying glass icon 82, suggesting that the tap point 66 selects a zoom or magnification feature. The icon or graphic may be printed over the tap location, or may be actively displayed in the region of the tap point using a touch sensitive display panel or backlighting using LEDs to illuminate icons formed of a translucent material in the touch pad. If the icons are actively displayed, they may change based on the state of the electronic imaging device if desired to clarify the feature that may be selected by the associated tap point.

Other tap points may be included on the touch pad 20 as desired. For example, four tap points (e.g., 84) with arrow icons may be located at the top, bottom, left and right on the annular region 60 to establish directional buttons for navigating through menus or thumbnail arrays in a non-scrolling manner. Other graphics may be included on or near the touch pad 20 to clarify the use of the touch pad 20. For example, an arcuate arrow icon 86 may be provided adjacent the touch pad 20 indicating the rotary nature of the touch pad 20, informing the user that a circular sweeping motion around the annular region 60 may be used to control features of the electronic imaging device, such as zooming in and out. Telephoto 90 and wide angle 92 icons may be provided at opposite ends of the arcuate arrow icon 86 indicating the directions to use for circular sweeping motions around the annular region 60 for a desired result. An inactive region 94 may also be provided on the back of the electronic imaging device, such as above the touch pad 20, so that the user can rest a thumb in the inactive region 94 to support the electronic imaging device without inadvertently manipulating the user interface.

The exemplary operation of the rotary touch pad 20 with tap points 64 and 66 for controlling an electronic imaging device will now be discussed. As indicated above, the features selected by the tap points 64 and 66 may vary depending on the state of the electronic imaging device. When the electronic imaging device is in a capture or live view mode, the touch pad 20 may default to controlling the zoom or focal length of the lens when the user rotates a finger around the annular region 60, for example using a counterclockwise motion to zoom in and a clockwise motion to zoom out. In this mode, a live view of the subject may be displayed on the display panel 16, along with status information such as the current setting for the feature being adjusted by the touch pad 20 (e.g., focal length). One or more tap points may be defined on the touch pad 20 to change the functionality of the touch pad 20 scrolling to scroll through aperture settings, shutter speed or manual focus settings. One tap point may be established for each available feature in a given state, or a tap point may be repeatedly tapped to cycle through different features as desired.

When the electronic imaging device is in a playback mode, the touch pad 20 may be used to scroll through stored images for display or deletion, or to zoom in and out on a stored image displayed on the display panel 16. In playback mode, the touch pad 20 may default to an image select mode in which the user rotates a finger around the annular region 60 to scroll through stored images, either one by one in a full screen view or by navigating in an array of thumbnails displayed on the display panel 16. If the magnifying glass tap point 66 is tapped, the magnification feature of the electronic imaging device is selected so that sweeping motions around the touch pad 20 zoom in and out of the stored image displayed on the display panel 16. If arrow touch points (e.g., 84) are established on the touch pad 20, they may be used to pan around in the displayed image when it is zoomed in and only a portion of the image is visible on the display panel 16. If the thumbnail array tap point 64 is tapped, the display panel 16 will be returned to full screen view, fully displaying a stored image, and the touch pad 20 is again set to the image select mode so that sweeping motions around the touch pad 20 scroll through stored images one by one. For example, a counterclockwise motion around the annular region 60 may step one by one through increasingly older stored images, a clockwise motion around the annular region 60 may step one by one through increasingly newer stored images.

If the thumbnail array tap point 64 is tapped again, an array of thumbnail images representing the stored images will be displayed on the display panel 16, and the touch pad 20 will be set to a thumbnail select feature so that sweeping motions around the touch pad 20 scroll through thumbnail images in the array. For example, a counterclockwise motion around the annular region 60 may step continuously to the left in the array until the left edge of the array is reached, then up to the rightmost thumbnail in the previous row of the array, and so on. A clockwise motion around the annular region 60 may step continuously to the right in the array until the right edge of the array is reached, then down to the leftmost thumbnail in the next row of the array, and so on. Again, if arrow touch points (e.g., 84) are established on the touch pad 20, they may also be tapped to navigate in the array of thumbnail images by moving up, down, left or right. If the magnifying glass tap point 66 is tapped again from this point, the display panel 16 is returned to the full screen view where the user can once again scroll through stored images with the touch pad 20.

Exemplary features of an electronic imaging device that may be controlled by a touch pad and selected by one or more tap points include the following:
Zoom
Focus Distance
Aperture
Shutter Speed
Exposure Compensation
Flash Setting
White Balance
Iso Speed
Contrast Setting
Saturation
Sharpness
Exposure Metering Region
Focus Zone
Scrolling Through Full Screen Images
Magnification of Image
Panning of Magnified Image
Scrolling Through Thumbnails of Images
Stepping Through Frames of a Video Clip
Rotating an Image
Adjusting the Size of a Border Applied to an Image
Adjusting the Color of a Tint Applied to an Image
Adjusting Any Variable of Artistic Effect Applied to an Image
Scrolling Through Menu Options
Adjusting Crop Box for Cropping an Image

Referring now to FIG. 6, an exemplary linear touch pad 100 with tap points will be described. This touch pad 100 and its tap points (e.g., 102 and 104) operates in substantially the same manner as described above with respect to the rotary touch pad 20, except that sweeping motions across the touch pad 100 to scroll a feature of the electronic imaging device are substantially linear, moving back and forth across a scroll strip region 106 rather than around the annular region 60 of the rotary touch pad 20. Tap points are provided as desired on the touch pad 100 to select the feature of the electronic imaging device being scrolled or controlled by the touch pad 100. For example, a thumbnail array tap point 102 is provided at the left side 110 of the touch pad 100 and a magnifying glass tap point 104 is provided at the right side 112 of the touch pad 100. The tap points 102 and 104 may have any size and shape desired, such as a square shape 114 or a round shape 116. The tap points 102 and 104 may also have a rectangular shape (e.g., 120) that is large enough to contain icons (e.g., 122 and 124) suggesting the feature associated with the tap point and the direction for sweeping motions over the scroll strip region 106, thereby forming a “dumbbell” shaped touch pad 100 with the tap points 102 and 104 at the left and right sides 110 and 112 surrounding a central elongated linear scroll strip region 106. Additional control buttons such as up 130 and down 132 arrows or an “OK” button 134 may also be provided near the touch pad 100 as desired to provide additional functionality for the user interface of the electronic imaging device, such as navigating through a menu or thumbnail array (using the arrow buttons 130 and 132) or selecting a menu item or image or confirming an operation such as deleting an image (using the OK button 134). The actions of the tap points 102 and 104 to select the feature being scrolled by the touch pad 100, and the action of the touch pad 100 to scroll through a selected feature of an electronic imaging device, may operate in substantially the same manner as described above with respect to the rotary touch pad 20.

A scrolling touch pad with tap points to select the function of the touch pad greatly simplify and optimize the control buttons used to control an electronic imaging device. The exemplary embodiments described herein also provide the distinct benefit of matching up the zoom and magnify controls in capture and playback modes, while still allowing the user to use the touch pad for other scrolling functions in playback mode such as image and thumbnail scrolling and in capture mode such as aperture, shutter speed and manual focus scrolling. Alternative configurations of the tap points on a scrolling touch pad may be used to provide other desired benefits. More generally, the touch pad with tap points provides the flexibility to use a scrolling touch pad, whether rotary, linear or some other configuration, in a direct and simple manner to control multiple features of an electronic imaging device without requiring additional buttons or menus to toggle the functionality.

While illustrative embodiments have been described in detail herein, it is to be understood that the concepts disclosed herein may be otherwise variously embodied and employed, and that the appended claims are intended to be construed to include such variations, except as limited by the prior art.

What is claimed is:

1. A method for controlling an electronic imaging device, the method comprising:
detecting a sweeping motion on a touch pad, and scrolling a feature of said electronic imaging device in response; and
detecting a tap on a predetermined location on said touch pad, and in response selecting one of a plurality of features of said electronic imaging device to be scrolled when a next sweeping motion is detected on said touch pad.

2. The method of claim 1, wherein said plurality of features comprises at least one member selected from the group consisting of zoom, focus distance, aperture, shutter speed, exposure compensation, flash setting, white balance, ISO speed, contrast setting, saturation, sharpness, exposure metering region, and focus zone.

3. The method of claim 1, wherein said plurality of features comprises at least one member selected from the group consisting of scrolling through full screen images, magnification of images, panning of magnified images, scrolling through thumbnails of images, stepping through frames of a video clip, rotating an image, adjusting a size of a border applied to an image, adjusting a color of a tint applied to an image, adjusting any variable of artistic effect applied to an image, scrolling through menu options, and adjusting crop box for cropping an image.

4. The method of claim 1, wherein said touch pad comprises a plurality of tap locations, one for each of said plurality of features, said predetermined location comprising one of said plurality of tap locations, and wherein said detecting said tap and said selecting comprises identifying which of said plurality of tap locations was tapped and selecting an associated one of said plurality of features.

5. The method of claim 1, wherein said touch pad comprises at least one predetermined location for which said control system selects a different feature of said electronic imaging device to be scrolled by said touch pad depending on a current state of said electronic imaging device.

6. The method of claim 1, wherein said electronic imaging device is in a playback mode, said touch pad is associated with a magnification feature for an image displayed on said electronic imaging device, and said image is magnified so that only a portion of said image is visible, wherein detecting a tap on a thumbnail tap location causes said control system to zoom out to fully display said image in a full screen view and to select an image select feature so that sweeping motions on said touch pad scroll through images stored on said electronic imaging device.

7. The method of claim 1, wherein said electronic imaging device is in a playback mode, said touch pad is associated with an image select feature so that sweeping motions on said touch pad scroll through images stored on said electronic imaging device, and an image is fully displayed on said electronic imaging device, wherein detecting a tap on a thumbnail tap location causes said control system to display an array of thumbnail images and to select a thumbnail select feature so that sweeping motions on said touch pad scroll through said array of thumbnail images.

8. The method of claim 1, wherein said electronic imaging device is in a playback mode and said touch pad is associated with a thumbnail select feature so that sweeping motions on said touch pad scroll through an array of thumbnail images displayed on said electronic imaging device, wherein detecting a tap on a magnifying glass tap location causes said control system to fully display a single image in a full screen view and to select an image select feature so that sweeping motions on said touch pad scroll through images stored on said electronic imaging device.

9. The method of claim 1, wherein said electronic imaging device is in a playback mode and said touch pad is associated with an image select feature so that sweeping motions on said touch pad scroll through images stored on said electronic imaging device, wherein detecting a tap on a magnifying glass tap location causes said control system to select a magnification feature so that sweeping motions on said touch pad vary a magnification of an image displayed on said electronic imaging device.

10. The method of claim 1, wherein said electronic imaging device is in a capture mode and said touch pad is associated with a zoom feature for a variable focal length lens, wherein detecting a tap on a thumbnail tap location causes said control system to select at least one feature selected from the group consisting of aperture setting, shutter speed and manual focus to be scrolled by sweeping motions on said touch pad.

11. A user interface for an electronic imaging device comprising:
a touch pad having at least one tap location defined thereon; and
a control system adapted to detect sweeping motions against said touch pad and in response to manipulate a feature of said electronic imaging device associated with said touch pad, said control system further adapted to detect a tap against said at least one tap location and in response to associate a different feature of said electronic imaging device with said touch pad.

12. The user interface of claim 11, said touch pad having a plurality of tap locations, wherein each feature of said electronic imaging device to be manipulated by said touch pad is associated with one of said plurality of tap locations.

13. The user interface of claim 11, wherein an icon is displayed adjacent said at least one tap location suggesting at least one feature of said electronic imaging device to be associated with said touch pad when a tap location adjacent said icon is tapped.

14. The user interface of claim 11, said touch pad having an annular shape, said control system being adapted to detect substantially curvilinear sweeping motions around said touch pad.

15. The user interface of claim 11, said touch pad having an elongate linear shape, said control system being adapted to detect substantially linear sweeping motions along said touch pad.

16. An electronic imaging device, comprising:
means for entering input to control a function of said electronic imaging device; and
means for associating a different function of said electronic imaging device with said means for entering input, wherein said means for associating is contained within said means for entering input.
